(19) United States
(12) Patent Application Publication
(10) Pub. No.: US 2021/0351418 A1
(43) Pub. Date: Nov. 11, 2021

(54) INTERMEDIATE TEMPERATURE METAL SUPPORTED SOLID OXIDE ELECTROLYZER

(71) Applicant: RAYTHEON TECHNOLOGIES CORPORATION, Farmington, CT (US)

(72) Inventors: Tianli Zhu, Glastonbury, CT (US); Justin R. Hawkes, Marlborough, CT (US); Joseph C. Rampone, Colchester, CT (US)

(21) Appl. No.: 17/262,246

(22) PCT Filed: Jul. 25, 2018
(86) PCT No.: PCT/US2018/043680

§ 371 Date: Jan. 22, 2021

(51) Int. Cl. H01M 4/90; C25B 9/73; C25B 9/23; H01M 8/126; C25B 15/08; H01M 4/86

(52) U.S. Cl. CPC H01M 4/9066; C25B 9/73; H01M 4/8605; H01M 8/126; C25B 15/08; C25B 9/23

(57) ABSTRACT

A metal-supported electrolyzer includes an electrolysis cell that has, in stacked order, an electrode unit having a first solid oxide electrode layer, a solid oxide electrolyte layer that is proton-conductive in a temperature range of 650° C. or lower, and a second solid oxide electrode layer. A porous metal sheet in contact with the second solid oxide electrode layer supports the electrode unit, a metal separator sheet bonded to the porous metal sheet, and a metal interconnect backing the metal separator sheet.

### BACKGROUND

Solid oxide electrolyzers use input electricity to drive redox reactions. In the case of water electrolysis for hydrogen production, the electrolyzer decomposes water into oxygen and hydrogen. Such electrolyzers typically include anode and cathode electrodes between which there is an oxygen ion-conducting layer. At the cathode, water molecules are chemically reduced into hydrogen and oxygen ions. The oxygen ions are conducted across the oxygen ion-conducting layer to the anode electrode. At the anode electrode the complimentary oxidation reaction occurs to combine oxygen ions into dioxygen.

The oxygen ion-conducting layer is typically formed of a ceramic oxide that conducts oxygen ions at temperatures of 700° C. to 1000° C. The electrolyzer may include various interconnects and flow channels for introducing the water and collecting the hydrogen and oxygen. In order to enhance durability against corrosion, the interconnects and flow channels are formed of highly specialized corrosion-resistant materials and may be coated to further protect against corrosion and thermal effects.

### SUMMARY

A metal-supported electrolyzer according to an example of the present disclosure includes an electrolysis cell that has, in stacked order, an electrode unit having a first solid oxide electrode layer, a solid oxide electrolyte layer that is proton-conductive in a temperature range of 650° C. or lower, and a second solid oxide electrode layer. A porous metal sheet in contact with the second solid oxide electrode layer supports the electrode unit, a metal separator sheet bonded to the porous metal sheet, and a metal interconnect backing the metal separator sheet.

In a further embodiment of any of the foregoing embodiments, the solid oxide electrolyte layer includes at least one of yttrium-doped barium zirconate or gadolinium-doped ceria.

In a further embodiment of any of the foregoing embodiments, the porous metal sheet includes a pattern of through-holes.

In a further embodiment of any of the foregoing embodiments, the porous metal sheet is stainless steel.

In a further embodiment of any of the foregoing embodiments, the through-holes have diameters of 50 micrometers to 100 micrometers.

In a further embodiment of any of the foregoing embodiments, the porous metal sheet has a porosity of 10% to 30%.

In a further embodiment of any of the foregoing embodiments, the porous metal sheet is metallurgically bonded to the metal separator sheet.

In a further embodiment of any of the foregoing embodiments, the first solid oxide electrode layer and the second solid oxide electrode layer each has a thickness of 10 micrometers to 100 micrometers.

In a further embodiment of any of the foregoing embodiments, the solid oxide electrolyte layer has a thickness of 1 micrometer to 50 micrometers and is less than each of the thicknesses of the first solid oxide electrode layer and the second solid oxide electrode layer.

In a further embodiment of any of the foregoing embodiments, the solid oxide electrolyte layer includes yttrium-doped barium zirconate.

In a further embodiment of any of the foregoing embodiments, the first solid oxide electrode layer and the second solid oxide electrode layer each has a thickness of 1 micrometers to 50 micrometers.

In a further embodiment of any of the foregoing embodiments, the solid oxide electrolyte layer has a thickness of 1 micrometer to 100 micrometers and is less than each of the thicknesses of the first solid oxide electrode layer and the second solid oxide electrode layer.

In a further embodiment of any of the foregoing embodiments, the porous metal sheet is stainless steel.

In a further embodiment of any of the foregoing embodiments, the porous metal sheet is ferritic stainless steel.

In a further embodiment of any of the foregoing embodiments, the porous metal sheet is metallurgically bonded to the metal separator sheet.

In a further embodiment of any of the foregoing embodiments, the porous metal sheet, the metal separator sheet, and the metal interconnect are stainless steel.

A further embodiment of any of the foregoing embodiments includes a power supply inputting electrical energy into the electrolysis cell.

In a further embodiment of any of the foregoing embodiments, the porous metal sheet has an average pore size of 1 micrometer to 200 micrometers.

A metal-supported electrolyzer according to an example of the present disclosure includes an electrolysis cell that has, in stacked order, an electrode unit having a first solid oxide electrode layer, a solid oxide electrolyte layer that is ion-conductive, and a second solid oxide electrode layer. A porous metal sheet in contact with the second solid oxide electrode layer supports the electrode unit, a metal separator sheet bonded to the porous metal sheet, and a second metal interconnect backing the first metal interconnect.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example electrolyzer.

FIG. 2A illustrates an example repeat cell of the electrolyzer.

FIG. 2B illustrates an expanded view of the repeat cell of FIG. 2A.

FIG. 3 illustrates an example electrode unit.

FIG. 4 illustrates an electrode unit on a porous metal sheet.

FIG. 5 illustrates a portion of an example porous metal sheet.

### DETAILED DESCRIPTION

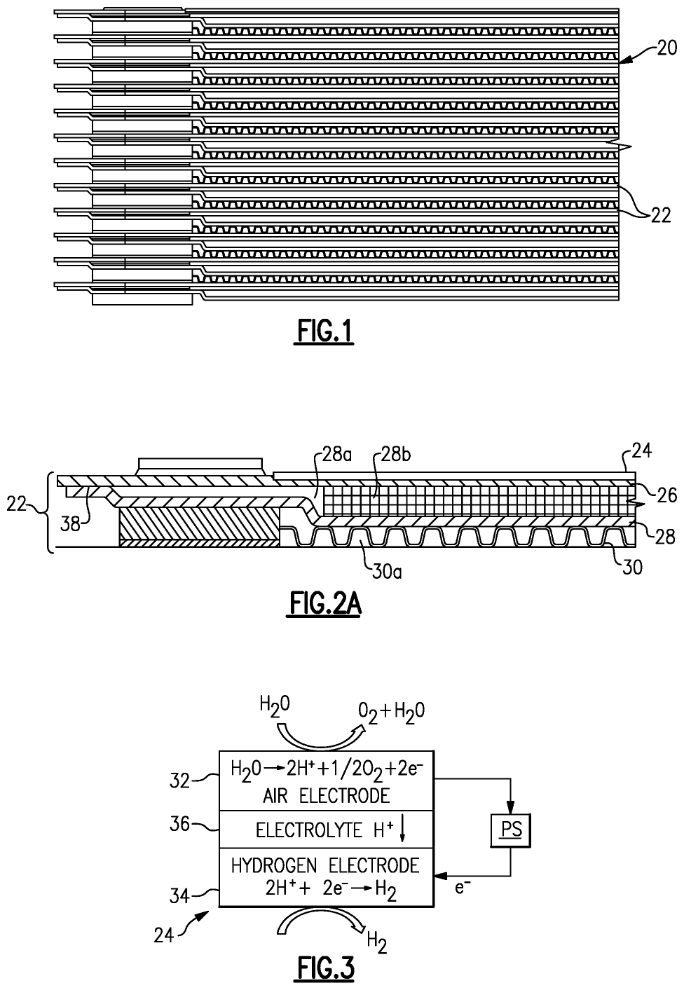

FIG. 1 illustrates an example electrolyzer 20. In this example, the electrolyzer 20 includes a stack of electrolysis cells 22, although it is to be understood that additional or fewer cells 22 than shown may be used. As will be described below, the electrolysis cells 22 are designed to operate in a lower temperature regime with regard to conductivity than typical electrolyzer cells and, as a result, can utilize materials and cell designs that would not be feasible at the higher temperatures.

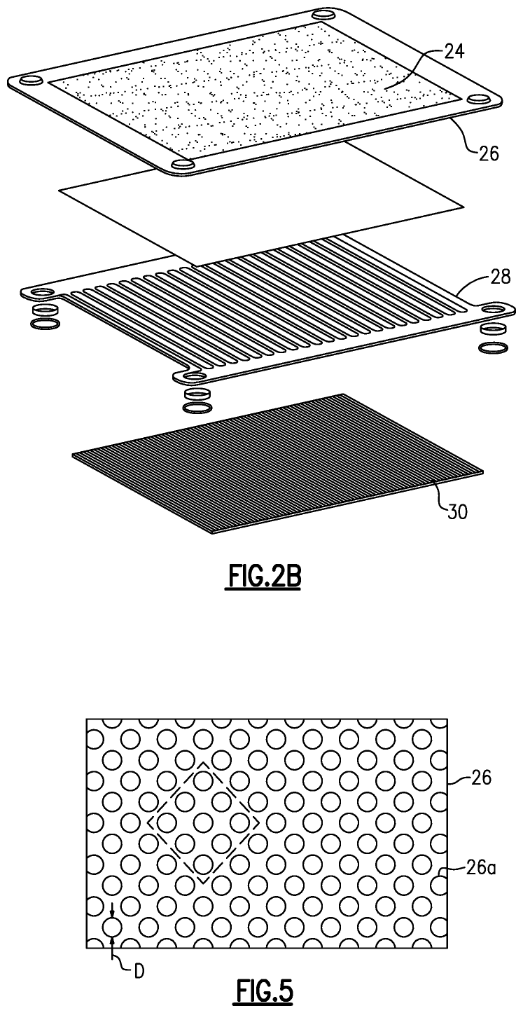

FIG. 2A illustrates a representative example of one of the cells 22, which is also shown in an expanded view in FIG. 2B. The cell 22 includes, in stacked order, an electrode unit 24, a porous metal sheet 26, a metal separator sheet 28 bonded to the porous metal sheet 26, and a metal interconnect 30 backing the metal separator sheet 28. The metal separator sheet 28 is a solid (non-porous) layer. The metal separator sheet 28 and the metal interconnect 30 may define respective flow channels 28a/30a for, respectively, product flow (e.g., hydrogen) and reactant flow (e.g., air/steam). For instance, the metal separator sheet 28 has a “dish” shape that defines the flow channels 28a, and the metal interconnect 30 has a wave or corrugated shape to define flow channels 30a. Optionally, a foam 28b or mesh may be provided in the channel 28a to mechanically reinforce the porous metal sheet 26. The foam 28b or mesh may be formed or a metal or ceramic, for example, and may be electrically conductive.

FIG. 3 shows a representative sectioned view of a portion of the electrode unit 24. The electrode unit 24 includes a first solid oxide electrode layer 32, a second solid oxide electrode layer 34, and a solid oxide electrolyte layer 36 that is between the electrode layers 32/34. As an example, the first solid oxide electrode layer 32 is formed of, but not limited to, PrBaSrCoFe double perovskite, LaSrCoFe (LSCF) or composite electrode consisting of LSCF and electrolyte material. The second solid oxide electrode layer 34 is formed of, but not limited to, nickel oxide and yttria stabilized zirconia, nickel oxide and gadolinia doped ceria, or combinations of these. The electrolyte layer 36 is ion-conductive in a temperature range of up to 650° C. In one further example, the electrolyte layer 36 is ion-conductive in a temperature range of 300° C. to 650° C., or 550° C. to 650° C. As an example, the electrolyte layer 36 is formed of or includes yttrium-doped barium zirconate, such as BaCe_{1-x-y}ZrxMyO_{3-δ}, where M can be Y, Yb, Nd, or Gd. Further examples include BaZr_{0.8}Y_{0.2}O_{3-δ} (BZY) and yttrium or ytterbium co-doped BaCeO3-BaZrO3, such as BaCeZrYYbO₃ or BaCe_{0.5}Zr_{0.3}Y_{0.2-x}YbₓO_{3-d}. The above are example of proton-conducting electrolytes, but the electrolyte layer 36 may alternatively be oxygen ion-conducting, such as gadolinium-doped ceria.

As also shown in FIG. 3, the electrolyzer 20 may further include a power source (PS), which is connected to provide electric current to drive the half reactions at the electrode layers 32/34. Such redox reactions are well-understood and are not further discussed herein.

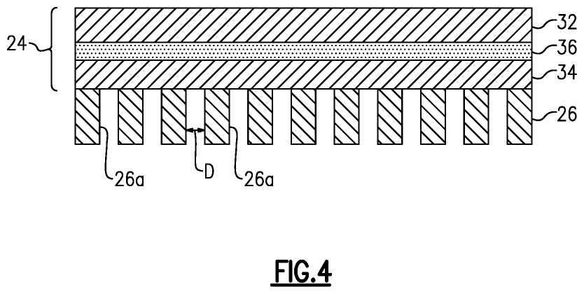

As shown in FIG. 4, the porous metal sheet 26 is in contact with the second solid oxide electrode layer 34. The porous metal sheet 26 supports the electrode unit 24. For example, the electrode unit 24 is not self-supporting and may crack under its own weight without the porous metal sheet 26 to bear the weight of the electrode unit 24.

As a result of the support provided by the porous metal sheet 26, the electrode layers 32/34 and the electrolyte layer 36 need not be of thicknesses for mechanical self-support. That is, the electrode layers 32/34 and the electrolyte layer 36 can be deposited as thin films directly onto the porous metal support 26. For example, the electrode layers 32/34 each have a thickness of 10 micrometers to 100 micrometers, and the electrolyte layer 36 has a thickness of 1 micrometer to 50 micrometers and is less than each of the thicknesses of the electrode layer 32/34. In a further example, the electrode layers 32/34 each have a thickness of 10 micrometers to 50 micrometers, and the electrolyte layer 36 has a thickness of 1 micrometer to 20 micrometers and is less than each of the thicknesses of the electrode layer 32/34

As a result of being deposited onto the porous metal sheet 26, and bonding thereto, there is no need for an intermediate glass bonding layer as in some prior solid oxide constructions. For instance, solid oxide layers are often thick and are disposed on a substrate. In order to assemble the layers into a unit cell a glass bonding layer must be used between the substrate and the mating structure. Because the electrode unit 24 is bonded to the porous metal sheet 26, the porous metal sheet can be metallurgically bonded to a mating structure, which in this case is the metal separator sheet 28. For instance, there is a metallurgical joint 38 (FIG. 2A) between the porous metal sheet 26 and the first metal interconnect 28. The metallurgical joint 38 may be formed by welding (e.g., laser welding) or brazing such that the channels 28a formed by the first metal interconnect 28 are fluidly isolated and sealed from the channels 30a formed by the second metal interconnect 30.

The porous metal sheet 26 in the illustrated example includes through-holes 26a, through which produced hydrogen flows to be collected. Alternatively, the porous metal sheet 26 may be formed of sintered metal powder or sintered metal fibers to provide porosity. As an example, although not shown to scale, the through-holes 26a may have diameters (D) of 50 micrometers to 100 micrometers and the porous metal sheet 26 may have a porosity of 10% to 30%. In the alternative that the porous metal sheet 26 is formed of sintered metal powder or sintered metal fibers to provide porosity, the pores may have an average pore size of 1 micrometer to 200 micrometers, with the porosity of 10% to 30%. As shown in FIG. 5, the through-holes 26a of the porous metal sheet 26 may be provided in a pattern, which includes through-holes 26a arranged in a unit 26b that repeats.

As a result of the electrolyte layer 36 being ion-conductive in the temperature range of up to 650° C., the metals that form the porous metal sheet 26, the metal separator layer 28, and the metal interconnect 30 need not be highly specialized or even coated to protect against high temperatures and corrosion. As an example, the porous metal sheet 26, the metal separator layer 28, and the metal interconnect 30 are formed of stainless steel, such as ferritic stainless steel. As used herein, stainless steel is a steel alloy that has, by weight, at least 10.5% of chromium. More preferably, however, the porous metal sheet 26 and metal interconnects 28/30 are formed of a stainless steel that has, by weight, at least 17% of chromium. Example stainless steels may include, but are not limited to, stainless steel alloys designated as 430 or 441 grade. At the given operating temperatures, corrosion of the stainless steels is not expected to be a limiting factor on the lifetime of the cell 22.

Additionally, the porous metal sheet 26 and the metal separator layer 28 have a high degree of manufacturability. For instance, the porous metal sheet 26 can be mass produced using high speed laser-drilling and the metal separator sheet 28 can be rapidly sheet-stamped in a press. This also enables low cost, scalable fabrication. Moreover, the cell 22 is expected to have good performance, such as fast start-up and shutdown and high power density.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A metal-supported electrolyzer comprising:
an electrolysis cell including, in stacked order,
an electrode unit having
a first solid oxide electrode layer,
a solid oxide electrolyte layer that is proton-conductive in a temperature range of 650° C. or lower, and
a second solid oxide electrode layer,
a porous metal sheet in contact with the second solid oxide electrode layer, the porous metal sheet supporting the electrode unit,
a metal separator sheet bonded to the porous metal sheet, and
a metal interconnect backing the metal separator sheet.

2. The metal-supported electrolyzer as recited in claim 1, wherein the solid oxide electrolyte layer includes at least one of yttrium-doped barium zirconate or gadolinium-doped ceria.

3. The metal-supported electrolyzer as recited in claim 2, wherein the porous metal sheet includes a pattern of through-holes.

4. The metal-supported electrolyzer as recited in claim 3, wherein the porous metal sheet is stainless steel.

5. The metal-supported electrolyzer as recited in claim 4, wherein the through-holes have diameters of 50 micrometers to 100 micrometers.

6. The metal-supported electrolyzer as recited in claim 5, wherein the porous metal sheet has a porosity of 10% to 30%.

7. The electrolyzer as recited in claim 6, wherein the porous metal sheet is metallurgically bonded to the metal separator sheet.

8. The metal-supported electrolyzer as recited in claim 7, wherein the first solid oxide electrode layer and the second solid oxide electrode layer each has a thickness of 10 micrometers to 100 micrometers.

9. The metal-supported electrolyzer as recited in claim 8, wherein the solid oxide electrolyte layer has a thickness of 1 micrometer to 50 micrometers and is less than each of the thicknesses of the first solid oxide electrode layer and the second solid oxide electrode layer.

10. The metal-supported electrolyzer as recited in claim 1, wherein the solid oxide electrolyte layer includes yttrium-doped barium zirconate.

11. The metal-supported electrolyzer as recited in claim 1, wherein the first solid oxide electrode layer and the second solid oxide electrode layer each has a thickness of 1 micrometers to 50 micrometers.

12. The metal-supported electrolyzer as recited in claim 11, wherein the solid oxide electrolyte layer has a thickness of 1 micrometer to 100 micrometers and is less than each of the thicknesses of the first solid oxide electrode layer and the second solid oxide electrode layer.

13. The metal-supported electrolyzer as recited in claim 1, wherein the porous metal sheet is stainless steel.

14. The metal-supported electrolyzer as recited in claim 1, wherein the porous metal sheet is ferritic stainless steel.

15. The metal-supported electrolyzer as recited in claim 1, wherein the porous metal sheet is metallurgically bonded to the metal separator sheet.

16. The metal-supported electrolyzer as recited in claim 1, wherein the porous metal sheet, the metal separator sheet, and the metal interconnect are stainless steel.

17. The metal-supported electrolyzer as recited in claim 1, further comprising a power supply inputting electrical energy into the electrolysis cell.

18. The metal-supported electrolyzer as recited in claim 1, wherein the porous metal sheet has an average pore size of 1 micrometer to 200 micrometers.

19. A metal-supported electrolyzer comprising:
an electrolysis cell including, in stacked order,
an electrode unit having
a first solid oxide electrode layer,
a solid oxide electrolyte layer that is ion-conductive, and
a second solid oxide electrode layer,
a porous metal sheet in contact with the second solid oxide electrode layer, the porous metal sheet supporting the electrode unit,
a metal separator sheet bonded to the porous metal sheet, and
a second metal interconnect backing the first metal interconnect.
